(19) United States
(12) Patent Application Publication
(10) Pub. No.: US 2005/0102691 A1
(43) Pub. Date: May 12, 2005

(54) Optical disk drive

(76) Inventor: Hsien-Tsung Chiu, Guishan Shiang (TW)

Correspondence Address: SNELL & WILMER;ONE ARIZONA CENTER, 400 EAST VAN BUREN, PHOENIX, AZ, 850040001, US

(21) Appl. No.: 10/916,963

(22) Filed: Aug. 12, 2004

(30) Foreign Application Priority Data
Nov. 11, 2003 (TW) 92131515

(51) Int. Cl. G11B 33/14; G11B 33/08; G11B 33/02

(52) U.S. Cl. 720/651

(57) ABSTRACT

An optical disk drive is provided in the present invention. The optical disk drive includes a housing, a chassis connected to the housing for supporting a pickup, a support device connected to the housing for supporting the chassis, and an elastic device. When accidental forces are applied on the optical disk drive, the elastic device prevents the optical disk drive from breakdown caused by the vibration from the accidental force, to maintain the function and operational stability of the optical disk drive.

### CROSS-REFERENCE TO RELATED APPLICATIONS

This Application claims priority to Taiwan Patent Application No. 92131515 entitled “Storage Media Read-Write Apparatus,” filed on Nov. 11, 2003.

### FIELD OF INVENTION

The present invention relates to an optical disk drive for a storage medium, and more particularly to an optical disk drive that includes an elastic device to prevent the optical disk drive from breakdown caused by vibration from accidental forces and to maintain the function and operational stability of the optical disk drive.

### BACKGROUND OF THE INVENTION

There are two sources of vibration in an optical disk drive. One is an internal source caused by the rotation of the compact disc; the other source is external forces, such as an accidental impact.

FIG. 1a shows a schematic diagram of a pickup of the optical disk drive of prior art. As shown in FIG. 1a, the optical disk drive includes a chassis 101 connected to the housing (not illustrated), and the chassis 101 carries a pickup 103 and a motor 104. The optical disk drive also includes a support device 102 connected to the housing (not illustrated) and the support device 102 supports the chassis 101. There are a plurality of absorbers 105 disposed between the chassis 101 and the housing (or between the housing and the support device 102) to reduce vibrations caused by the rotation of the compact disc. The aforementioned method can prevent vibrations in the optical disk drive from transmitting outward.

But the foregoing design of vibration reduction cannot completely absorb vibrations caused by external forces because the absorbers 105 only absorb a limited amount of impact. As shown in FIG. 1b, a block wall 107 is disposed on the support device 102 to absorb the remaining energy of vibrations, but such a wall generally does not provide the desired vibration absorption.

### SUMMARY OF THE INVENTION

The present invention provides an optical disk drive including an elastic device. When an external force is applied on the optical disk drive causing extra vibrations, the elastic device prevents the optical disk drive from breakdown and maintains the function and operational stability of the optical disk drive.

The optical disk drive of the present invention includes a housing, a chassis connected to the housing for supporting a pickup, a support device connected to the housing for supporting the chassis, and an elastic device for absorbing impact caused by vibrations.

The elastic device of the present invention prevents the optical disk drive from breakdown caused by vibrations from accidental forces and to maintain the function and operational stability of the optical disk drive.

### BRIEF DESCRIPTION OF THE DRAWINGS

FIG. 1a shows a schematic diagram of a pickup of the optical disk drive of prior art.

FIG. 1b shows a schematic diagram of a support device of the optical disk drive of prior art.

FIG. 2 shows a schematic diagram of a support device of one embodiment of the present invention.

FIG. 3 shows a schematic diagram of a support device of another embodiment of the present invention.

FIG. 4a shows a schematic diagram of an elastic device of one embodiment of the present invention.

FIG. 4b shows a schematic diagram of a support device of one embodiment of the present invention.

### DETAILED DESCRIPTION

The present invention provides an optical disk drive including an elastic device. The elastic device prevents the optical disk drive from breakdown caused by vibrations from accidental forces, to maintain the function and operational stability of the optical disk drive.

The preferred embodiment of the present invention is an optical disk drive. However, other embodiments include drives for other data storage media with the similar function.

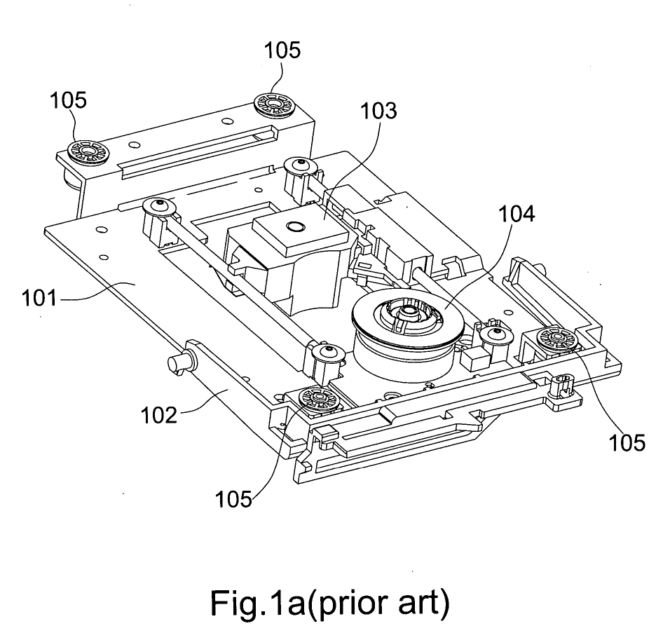

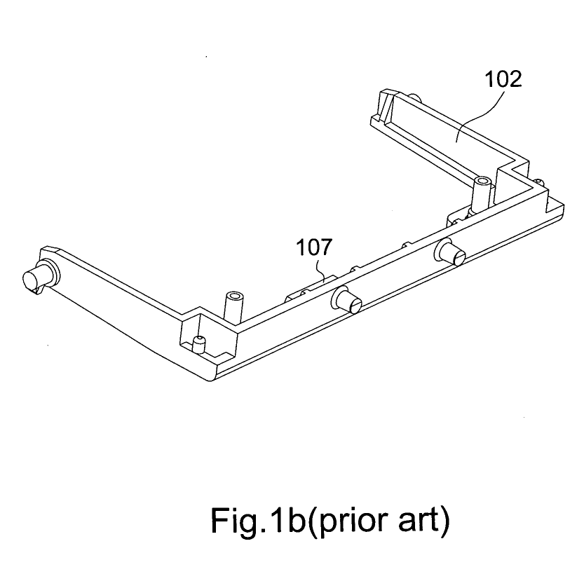

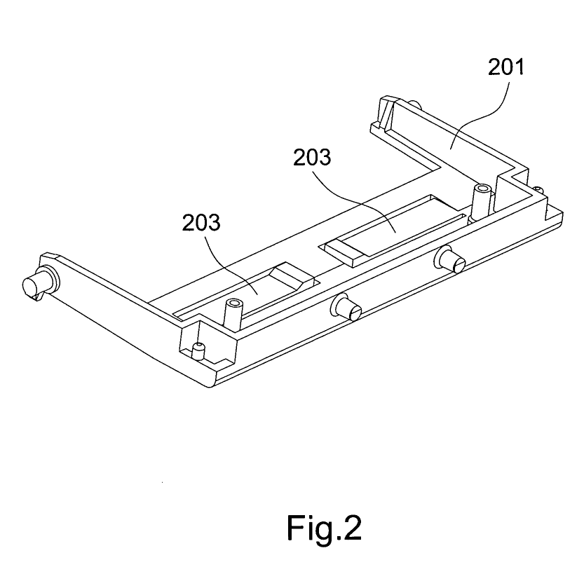

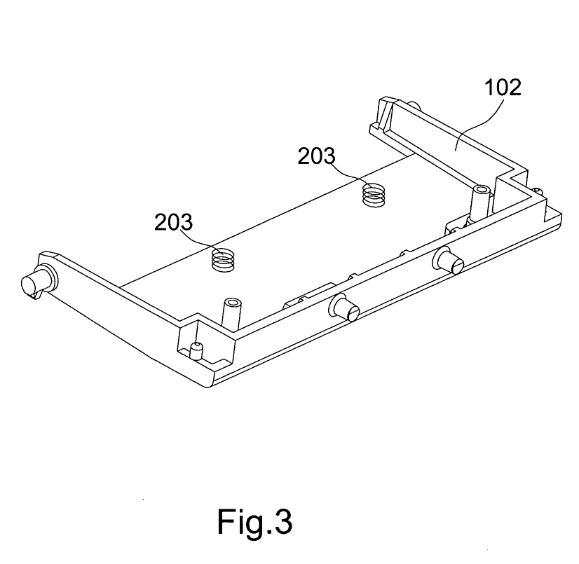

FIG. 2 shows a schematic diagram of a support device of one embodiment of the present invention. As shown in FIG. 2, the support device 201 includes an elastic device 203. In accordance with one aspect of this embodiment of the invention, the elastic devices 203 are elastic tabs formed integrally with the support device 201. As shown in FIG. 3, the elastic device 203 may suitably include a spring or the like in accordance with other embodiments. Referring to FIG. 1a, one embodiment of the present invent is created if we replace the supported device 102 in FIG. 1a with the support device 201 in FIG. 2 (not illustrated).

The elastic modulus of the elastic device 203 is larger than the elastic modulus of the absorber 105 (shown in FIG. 1a) and therefore absorb greater vibration caused by the impact of external forces. Furthermore, the difference between the elastic device 203 and traditional absorbers 105 is that the elastic device 203 does not come into contact with the chassis in the optical disk drive when no external forces are applied to the optical disk drive.

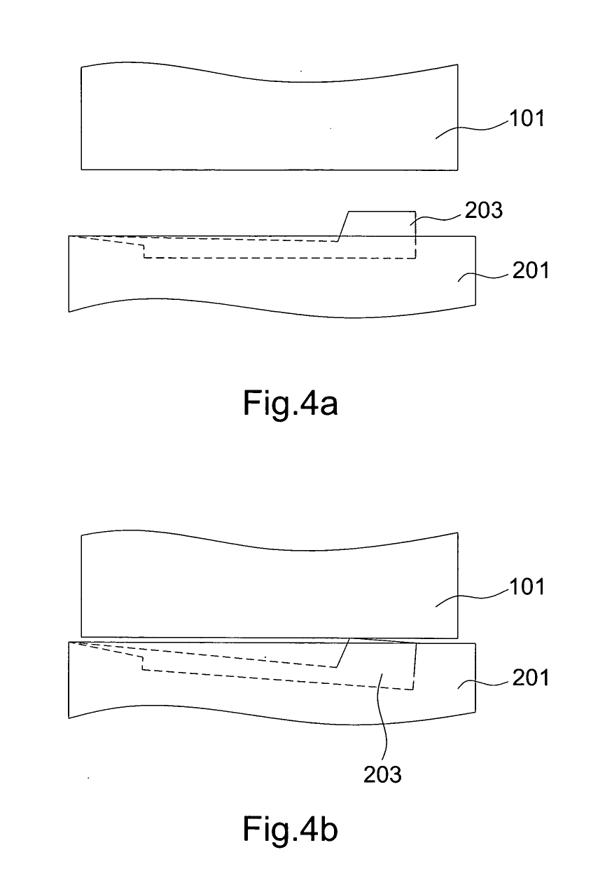

In this embodiment, the optical disk drive can reduce the effect caused by external impacts and maintain the operation stability. As shown in FIG. 4a, a portion of the elastic device 203 is higher than a main plane of the support device 102 when no external forces are applied to the optical disk drive. As shown in FIG. 4b, the elastic device 203 comes into contact with the chassis 101 and absorbs the impaction caused by external forces to provide protection to the optical disk drive when external forces are applied to the optical disk drive. In this embodiment, the elastic device 203 absorbs the forces applied in the direction mainly downward.

In another embodiment, the elastic device 203 can be disposed on the chassis 101, and the elastic device 203 does not come into contact with the housing at first. When external forces are applied on the optical disk drive, the elastic device 203 comes into contact with the housing and absorbs the vibrations caused by the external forces to enhance the protection afforded the optical disk drive.

While the invention has been described in connection with what is presently considered to be the most practical and preferred embodiments, it is to be understood that the invention is not to be limited to the discovered embodiments. The invention is intended to cover various modifications and equivalent arrangements included within the spirit and scope of the appended claims.

1. An optical disk drive comprising:
a housing;
a chassis for carrying a pickup, the chassis being connected to the housing;
a support device connected to the housing for supporting the chassis;
a shock absorber disposed between the support device and the chassis; and
an elastic device disposed on the support device with a distance from the chassis;
wherein as an external force larger than a limit of the shock absorber is applied on the optical disk drive, the chassis contacts the elastic device and the elastic device absorbs a force applied on the chassis to thereby protect the optical disk drive.

2. The optical disk drive according to claim 1, wherein a portion of the elastic device is higher than a plane of the support device.

3. The optical disk drive according to claim 1, wherein the elastic device is an elastic tab formed integrally with the support device.

4. The optical disk drive according to claim 1, wherein the elastic device is a spring.

5. The optical disk drive according to claim 1, wherein the elastic device starts to absorb the force when the distance equals zero.

6. An optical disk drive for a storage medium comprising:
a housing;
a chassis for carrying a pickup, the chassis being connected to the housing;
a shock absorber disposed between the housing and the chassis; and
an elastic device disposed on the chassis with a distance from the housing;
wherein as an external force larger than a limit of the shock absorber is applied to the storage media optical disk drive, the housing contacts the elastic device and the elastic device absorbs a force applied on the housing to enhance protection to the optical disk drive.

7. The optical disk drive according to claim 6, wherein a portion of the elastic device is higher than a plane of the chassis.

8. The optical disk drive according to claim 6, wherein the elastic device is an elastic tab formed integrally with the chassis.

9. The optical disk drive according to claim 6, wherein the elastic device is a spring.

10. The optical disk drive according to claim 6, wherein the elastic device starts to absorb the force when the distance equals zero.

11. An optical disk drive for a storage medium comprising:
a housing;
a chassis for carrying a pickup, the chassis being connected to the housing;
a support device connected to the housing, for supporting the chassis; and
an elastic device disposed on the support device with a distance from the chassis;
wherein as an external force larger than a limit of the shock absorber is applied on the storage media optical disk drive, the chassis contacts the elastic device and the elastic device absorbs a force applied on the chassis to enhance protection to the optical disk drive.

12. The optical disk drive according to claim 11, wherein a portion of the elastic device is higher than a plane of the support device.

13. The optical disk drive according to claim 11, wherein the elastic device is an elastic tab formed integrally with the support device.

14. The optical disk drive according to claim 11, wherein the elastic device is a spring.

15. The optical disk drive according to claim 11, wherein the elastic device starts to absorb the force when the distance equals zero.
